(19) United States
(12) Patent Application Publication
(10) Pub. No.: US 2015/0363710 A1
(43) Pub. Date: Dec. 17, 2015

(54) METHODS AND SYSTEMS FOR TRACKING INVENTORY

(71) Applicant: Superior Drilling Products, Inc., Vernal, UT (US)

(72) Inventors: Gilbert Troy Meier, Vernal, UT (US); James D. Osterloh, West Richland, WA (US); Joshua J. Smith, Vernal, UT (US); David Gale, Vernal, UT (US); Aaron Anderson, Vernal, UT (US); Brian Greene, Vernal, UT (US); Taylor Sorensen, Vernal, UT (US)

(21) Appl. No.: 14/302,236

(22) Filed: Jun. 11, 2014

(51) Int. Cl. G06Q 10/06; G06Q 10/08

(52) U.S. Cl. CPC G06Q 10/06; G06Q 10/087

(57) ABSTRACT

Systems and methods for tracking a device are disclosed. The system comprises an identification plate coupled to the device and laser engraved with a tracking identifier, the identification plate adapted to maintain the engraving under stress, elevated temperature, and wear conditions, and at least one computer adapted to read the tracking number and determine the location of the device.

### BACKGROUND

1. Field of the Invention

The invention is directed to methods and systems for tracking inventory. Specifically, the invention is directed to methods and systems for tracking devices that experience significant wear during use and/or refurbishment.

2. Background of the Invention

An inventory control system is a process for managing and locating objects or materials. Modern inventory control systems often rely upon barcodes (usually affixed with a sticker or printed directly on the object) and radio-frequency identification (RFID) tags to provide automatic identification of inventory objects and their locations. Inventory objects could include any kind of physical asset: merchandise, consumables, fixed assets, circulating tools, library books, or capital equipment. To record an inventory transaction, the system may use a barcode scanner or RFID reader to automatically identify the inventory object, and then collect additional information from the operators via fixed terminals (workstations), or mobile computers.

While traditional inventory control systems are sufficient for stores, shipping companies, libraries, hospitals, and other businesses, using RFID or conventional barcodes on objects that are subjected to high temperatures, excessive ware, stress, corrosion, and other abuse is undesirable. For example, barcodes and other visual identifiers can wear off and RFID chips can break or melt. Therefore it is desirable to have a inventory marker that is capable of withstanding significant wear and tear.

### SUMMARY OF THE INVENTION

The present invention overcomes the problems and disadvantages associated with current strategies and designs and provides new tools and methods of tracking inventory.

One embodiment of the invention is directed to a system for tracking a device. The system comprises an identification plate coupled to the device and laser engraved with a tracking identifier, the identification plate adapted to maintain the engraving under stress, elevated temperature, and wear conditions, and at least one computer adapted to read the tracking number and determine the location of the device.

In a preferred embodiment, the tracking identifier is at least one of a serial number and a barcode. Preferably, the identification plate is comprised of tungsten carbide. Preferably, the device is a drill bit, a reamer, a drill collar, a drill stabilizer, a downhole motor, a rotary steerable system, a measurement while drilling (MWD) tool, or a logging while drilling (LWD) tool.

In embodiments where the device is a drill bit, the system preferably tracks the drill bit through a refurbishment process and life cycle. Each station in the refurbishment process preferably comprises a computer adapted to read the tracking number. Preferably, each computer is in communication with a central processor that maintains a database of the location of a plurality of devices simultaneously.

The system preferably further comprises at least one barcode scanner coupled to each of the at least one computers. The identification plate is preferably permanently coupled to the device.

Another embodiment of the invention is directed to a method for tracking a device. The method includes the steps of laser engraving a tracking identifier into an identification plate, the identification plate adapted to maintain the engraving under stress, elevated temperature, and wear conditions, coupling the identification plate to the device, and tracking the location of the device with at least one computer adapted to read the tracking number.

Preferably the tracking identifier is at least one of a serial number and a barcode. In a preferred embodiment, the identification plate is comprised of tungsten carbide. Preferably, the device is a drill bit, a reamer, a drill collar, a drill stabilizer, a downhole motor, a rotary steerable system, a measurement while drilling (MWD) tool, or a logging while drilling (LWD) tool. In embodiments where the device is a drill bit, the method preferably tracks the drill bit through a refurbishment process and life cycle.

Preferably, each station in the refurbishment process comprises a computer adapted to read the tracking number. In a preferred embodiment, each computer is in communication with a central processor that maintains a database of the location of a plurality of devices simultaneously. The method preferably further comprises reading the tracking number with a barcode scanner coupled to each of the at least one computers. Preferably, the identification plate is permanently coupled to the device.

Other embodiments and advantages of the invention are set forth in part in the description, which follows, and in part, may be obvious from this description, or may be learned from the practice of the invention.

### DESCRIPTION OF THE DRAWING

The invention is described in greater detail by way of example only and with reference to the attached drawing, in which:

FIG. 1 is an embodiment of a computer system utilized by the invention.

FIG. 2 is an embodiment of the identification plate of the instant invention coupled to a drill bit.

FIG. 3 is an example of an identification plate of the instant invention.

### DESCRIPTION OF THE INVENTION

As embodied and broadly described herein, the disclosures herein provide detailed embodiments of the invention. However, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention

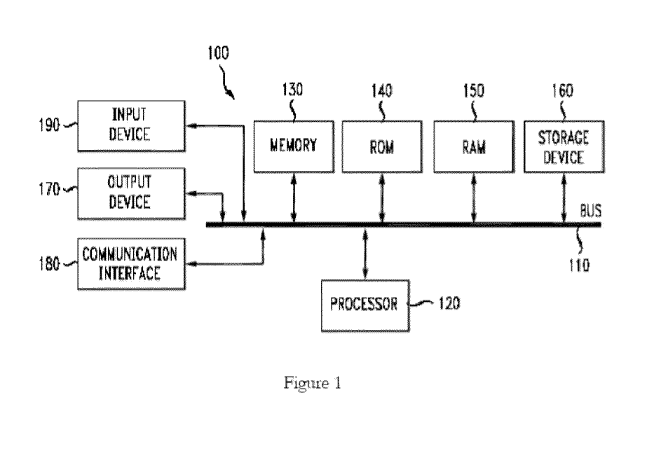

With reference to FIG. 1, an exemplary system includes at least one general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that portions of the invention may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive, a solid state memory drive, or the like. The storage device 160 is connected to the system bus 110 by a drive interface. The drives and the associated computer readable media provide nonvolatile storage of computer readable instructions, data structures, program modules and other data for the computing device 100. The basic components are known to those of skill in the art and appropriate variations are contemplated depending on the type of device, such as whether the device is a small, handheld computing device, a desktop computer, a computer server, or a wireless devices, including wireless Personal Digital Assistants (“PDAs”) (e.g., Palm™ VII, Research in Motion's Blackberry™, Apple's iPhone™, or Google's Android™), wireless web-enabled phones, other wireless phones, etc.

Although the exemplary environment described herein employs a hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a laser scanner, an optical scanner, a microphone for speech, a touch-sensitive screen for gesture or graphical input, keyboard, mouse, motion input and so forth. The device output 170 can be one or more of a number of output mechanisms known to those of skill in the art, for example, printers, monitors, projectors, speakers, and plotters. In some embodiments, the output can be via a network interface, for example uploading to a website, emailing, attached to or placed within other electronic files, and sending an SMS or MMS message. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Networks may include the Internet, one or more Local Area Networks (“LANs”), one or more Metropolitan Area Networks (“MANs”), one or more Wide Area Networks (“WANs”), one or more Intranets, etc. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

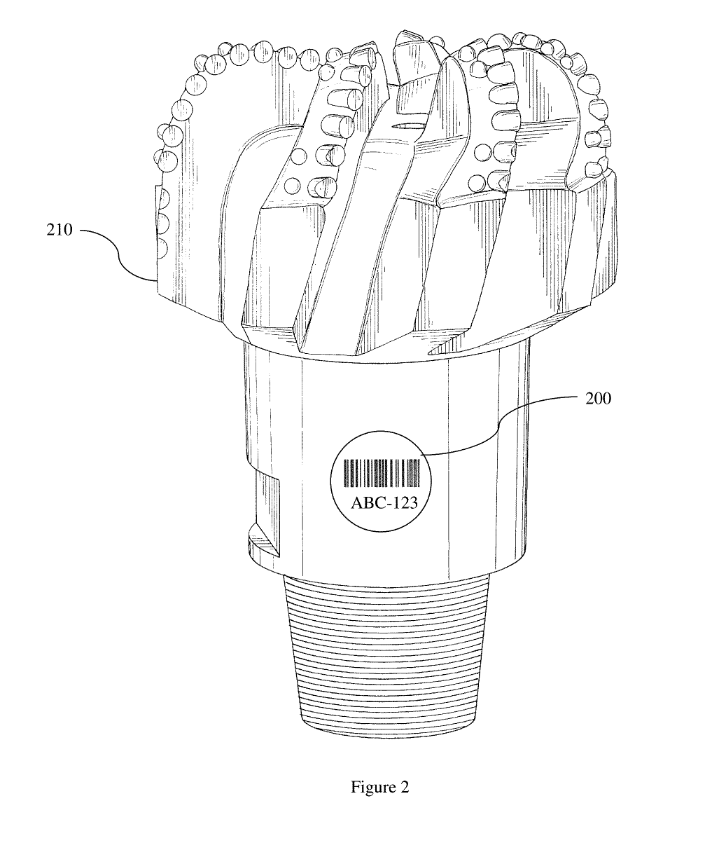

FIG. 2 depicts an identification plate 200. Identification plate 200 is preferably comprised of tungsten carbide. However, identification plate 200 can be comprised of titanium carbide, titanium diboride, diamond, corundum, silicon carbide, a polycrystalline diamond compact (PDC), or another hard material (e.g. having a Mohs hardness rating of above 6, preferably above 8, and more preferably 9 or more). Preferably the identification plate 200 is harder than the device to which the identification plate is affixed. Preferably identification plate 200 is engraved with an identifier. The identifier can be, for example, a barcode, a combination of numbers, letters, and/or symbols, a serial number, a 2-D barcode, or another visual identifier. Preferably the identifier is engraved with laser etching. For example, the engraving can be etched with a 10 W laser using multiple passes to achieve a etch depth of about 5 microns. In another example, a 30 W laser may create a 25 micron deep etch in 10 to 20 second. Higher or lower powered lasers may be used. Preferably, the laser is a YVO₄ laser, a YAG Laser or a Fiber Laser. The identifier can also be engraved with acid etching, carving, molding, or otherwise marked on identification plate 200. The etching may be dyed for better visibility and the dye may be reapplied as needed. Preferably, identification plate 200 is round. However, identification plate 200 can have another shape, such as rectangular, triangular, and ovular. Identification plate 200 is preferably 0.5 inches in diameter. However, identification plate 200 can be larger or smaller.

Identification plate 200 is preferably permanently coupled to the device to be tracked. For example, identification plate 200 can be welded, brazed, affixed with epoxy or another adhesive, bolted, riveted, friction fit, or otherwise coupled to the device. FIG. 2 depicts identification plate 200 coupled to a well bore drill 210. Well bore drill 210 is merely used as an example of the device. Identification plate 200 can be coupled to any device. For example, a reamer, a drill collar, a drill stabilizer, a downhole motor, a rotary steerable system, a measurement while drilling (MWD) tool, or a logging while drilling (LWD) tool, engine parts, axels, grinders, propellers, rotors, loader buckets, backhoe buckets, tractors, wheels, cutting devices, blades, hinges, and the like. Preferably, the device is an object that is routinely subjected to at least one of high temperature (e.g. over 500° F., over 1000° F., over 1500° F., or over 2000° F.) and significant stress conditions (e.g. erosion, corrosion, creep, fatigue, fracture, impact, thermal shock, wear, buckling, abrasion, erosion, and the like).

Preferably, the device is an object that is at least one of able to be maintained, refurbished, replaced, or retrofitted. The position of identification plate 200 shown in FIG. 2 is merely an example. Identification plate 200 can be position on another portion of the device, inside the device, or in multiple locations on the device. Preferably, the identification plate does not interfere with the function of the device. The identification plate 200 can be coated with a resistant material.

### Example

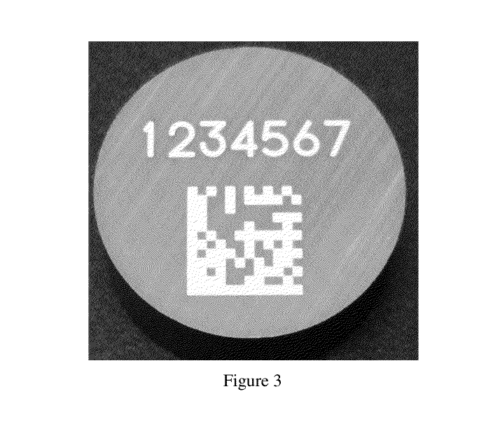

An example of identification plate, in practice is the tracking of a drill bit through a refurbishment process. The refurbishment process of a drill bit includes numerous steps. The drill bit undergoes various processes at several stations in order to replace worn out or broken parts and return the drill bit to “like-new” conditions. The various processes include, for example, heating, grinding, and impacting the drill bit. Each of these steps may cause a written or stuck on identifier to come off or be worn to the point that it is no longer legible. To avoid this problem, a tungsten carbide identification plate (as shown in FIG. 3) is brazed onto each drill bit that enters the refurbishment process. Each identification plate is engraved a unique serial number and barcode to track the drill bit through the process. Preferably, the identification plate and its engravings are able to withstand both the refurbishment process and use in the field without becoming illegible.

Preferably, at each step in the process, each drill bit is scanned with a barcode reader (e.g. either an optical scanner or a laser scanner) and the location of the drill bit is sent to a central computer to track the drill bit through the process. Preferably, each station has its own barcode reader for ease of determining the location of the drill bit in the process. Preferably, the central computer maintains a database of the location of all drill bits within the system simultaneously. Furthermore, the central computer can track the time the drill bit is being used in the field and its return for another refurbishment. By tracking the time in the field and the number of refurbishments, the central computer can predict the expected life of the drill bit.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims. Furthermore, the term “comprising of” includes the terms “consisting of” and “consisting essentially of.”

1. A system for tracking a device, comprising:
an identification plate coupled to the device and laser engraved with a tracking identifier, the identification plate adapted to maintain the engraving under stress, elevated temperature, and wear conditions; and
at least one computer adapted to read the tracking number and determine the location of the device.

2. The system of claim 1, wherein the tracking identifier is at least one of a serial number and a barcode.

3. The system of claim 1, wherein the identification plate is comprised of tungsten carbide.

4. The system of claim 1, wherein the device is a drill bit, a reamer, a drill collar, a drill stabilizer, a downhole motor, a rotary steerable system, a measurement while drilling (MWD) tool, or a logging while drilling (LWD) tool.

5. The system of claim 4, wherein the device is a drill bit and the system tracks the drill bit through a refurbishment process and life cycle.

6. The system of claim 5, wherein each station in the refurbishment process comprises a computer adapted to read the tracking number.

7. The system of claim 6, wherein each computer is in communication with a central processor that maintains a database of the location of a plurality of devices simultaneously.

8. The system of claim 1, further comprising at least one barcode scanner coupled to each of the at least one computers.

9. The system of claim 1, wherein the identification plate is permanently coupled to the device.

10. A method for tracking a device, comprising:
laser engraving a tracking identifier into an identification plate, the identification plate adapted to maintain the engraving under stress, elevated temperature, and wear conditions;
coupling the identification plate to the device; and
tracking the location of the device with at least one computer adapted to read the tracking number.

11. The method of claim 10, wherein the tracking identifier is at least one of a serial number and a barcode.

12. The method of claim 10, wherein the identification plate is comprised of tungsten carbide.

13. The method of claim 10, wherein the device is a drill bit, a reamer, a drill collar, a drill stabilizer, a downhole motor, a rotary steerable system, a measurement while drilling (MWD) tool, or a logging while drilling (LWD) tool.

14. The method of claim 13, wherein the device is a drill bit and the method tracks the drill bit through a refurbishment process and life cycle.

15. The method of claim 14, wherein each station in the refurbishment process comprises a computer adapted to read the tracking number.

16. The method of claim 15, wherein each computer is in communication with a central processor that maintains a database of the location of a plurality of devices simultaneously.

17. The method of claim 10, further comprising reading the tracking number with a barcode scanner coupled to each of the at least one computers.

18. The method of claim 10, wherein the identification plate is permanently coupled to the device.

19. The system of claim 1, wherein the identification plate is harder than the device.

20. The method of claim 10, wherein the identification plate is harder than the device.
